(19) United States
(12) Patent Application Publication
(10) Pub. No.: US 2021/0170380 A1
(43) Pub. Date: Jun. 10, 2021

(54) MAGNESIUM DICHLORIDE-ALCOHOL ADDUCTS AND CATALYST COMPONENTS OBTAINED THEREFROM

(71) Applicant: BASELL POLIOLEFINE ITALIA S.R.L., MILANO (IT)

(72) Inventors: SIMONA GUIDOTTI, FERRARA (IT); DARIO LIGUORI, FERRARA (IT); GIAMPIERO MORINI, FERRARA (IT)

(73) Assignee: BASELL POLIOLEFINE ITALIA S.R.L., MILANO (IT)

(21) Appl. No.: 16/771,845

(22) PCT Filed: Dec. 12, 2018
(86) PCT No.: PCT/EP2018/084554

§ 371 Date: Jun. 11, 2020

(30) Foreign Application Priority Data
Dec. 14, 2017 (EP) 17207439.5

(51) Int. Cl. B01J 31/12; C08F 4/654

(52) U.S. Cl. CPC B01J 31/122; C08F 110/06; C08F 4/6543

(57) ABSTRACT

A Mg compound based catalyst precursor made from or containing up to 50% by mols, with respect to Mg, of a compound of formula K(OR¹) wherein R¹ is H or a C₁-C₁₀ hydrocarbon group. When treated with transition metal compounds, the precursor is converted into catalyst with high activity in olefin polymerization.

### FIELD OF THE INVENTION

In general, the present disclosure relates to the field of chemistry. More specifically, the present disclosure relates to polymer chemistry. In particular, the present disclosure relates to magnesium based catalyst precursors containing one or more potassium based compounds.

### BACKGROUND OF THE INVENTION

In some instances, magnesium-based precursors of catalyst components for the polymerization of olefins are used for converting the precursors into magnesium chloride which is the active catalyst carrier for the transition metal (Ti, V, Zr).

In some instances, the starting magnesium compound is MgCl₂ or a Mg compound or complex which is convertible into magnesium halide by chemical reactions. In some instances, the MgCl₂ is activated by grinding.

In some instances, Mg starting compounds are made from or contain complexes between MgCl₂ and alcohols in various molar ratios represented by the formula MgCl₂n(ROH) where R is a C₁-C₁₀ hydrocarbon group.

In some instances, complexes are mixed with additional Lewis bases. While the activity is increased, organic compounds can generate ligands that modify other catalyst properties.

### SUMMARY OF THE INVENTION

In a general embodiment, the present disclosure provides a Mg compound based catalyst precursor made from or containing a complex of formula MgCl₂.n(ROH) wherein R is a C₁-C₁₀ hydrocarbon group and n ranges from 0.3 to 6, alternatively from 0.5 to 5, alternatively from 0.5 to 4, and up to 50% mol with respect to Mg, of a K compound selected from the group consisting of halides, carbonate, carboxylates R¹COO— and compounds of formula K(OR¹) wherein R¹ is H or a C₁-C₁₀ hydrocarbon group.

### DETAILED DESCRIPTION OF THE INVENTION

In some embodiments, the K compound is selected from the group consisting of chloride, alcoholates, carbonate, hydroxide and mixture thereof. In some embodiments, the K compound has the formula K(OR¹) wherein R¹ is H or a C₁-C₅ linear or branched alky group. In some embodiments, R¹ is H.

In some embodiments, R¹ is a C₁-C₅ alkyl group. In some embodiments, R¹ is ethyl or t-butyl.

In some embodiments, K(OR¹) compound is part of a complex. In some embodiments, K(OR¹) compound is in solid or liquid form.

In some embodiments, the K compound is present in the Mg based precursor in an amount lower than 25% molar, alternatively lower than 15%, alternatively lower than 7% mol based on the mol of Mg. In some embodiments, K content ranges from 1 to 4% mol based on the mol of Mg.

In some embodiments and in the complex of formula MgCl₂.n(ROH), R is a C₁-C₈ linear or branched hydrocarbon group, alternatively a C₁-C₄ linear hydrocarbon group. In some embodiments, R is ethanol.

In some embodiments, magnesium chloride, K compound and alcohol (ROH) are contacted. The system is heated until a molten liquid composition is formed which is subsequently dispersed in a liquid immiscible with the molten liquid composition, thereby yielding an emulsion. In some embodiments, the emulsion is rapidly cooled, thereby yielding solid particles of adduct. In some embodiments, the solid adduct particles are in spherical form. In some embodiments, the contact between magnesium chloride, the K compound, and the alcohol occur in the presence of an inert liquid immiscible with and chemically inert to the molten adduct. In some embodiments and when the inert liquid is present, the alcohol is added in vapor phase. It is believed that the vapor facilitates homogeneity of the formed adduct. In some embodiments, the inert liquid is selected from the group consisting of aliphatic hydrocarbons, aromatic hydrocarbons, cycloaliphatic hydrocarbons, and silicone oils. In some embodiments, the inert liquid is an aliphatic hydrocarbon. In some embodiments, the aliphatic hydrocarbon is vaseline oil. After the MgCl₂ particles, the alcohol and the K compound are dispersed in the liquid phase, the mixture is heated at a temperature at which the adduct reaches molten state. In some embodiments, the temperature ranges from 100 to 150° C. The temperature is maintained such that the adduct is completely melted. In some embodiments, the adduct is maintained in the molten state under stirring conditions, for a time period equal to or greater than 10 hours, alternatively from 10 to 150 hours, alternatively from 20 to 100 hours.

In some embodiments, the K compound is added to the adduct in a molten state that has been prepared by forming and heating a mixture of MgCl₂ and alcohol.

In some embodiments, solid discrete particles of the adduct in spherical form are obtained by emulsifying the adduct in a liquid medium which is immiscible with and chemically inert to the adduct and then quenching the emulsion with an inert cooling liquid.

In some embodiments, solidification of the adduct is achieved by spray-cooling. In some embodiments, the first step is contacting the magnesium chloride, the K compound and the alcohol to each other in the absence of an inert liquid dispersant. After melting the adduct, the adduct is sprayed at a low temperature, thereby causing rapid solidification of the particles. In some embodiments, the adduct is sprayed in a cold liquid environment, alternatively in a cold liquid hydrocarbon.

In some embodiments, the adduct particles are in spherical or spheroidal form. In some embodiments, the spherical particles have a ratio between maximum and minimum diameter lower than 1.5, alternatively lower than 1.3.

In some embodiments, the adduct has a particle size ranging from 5 to 150 microns, alternatively from 10 to 100 microns, alternatively from 15 to 80 microns.

In some embodiments, the adduct contains water. In some embodiments, the water is present in an amount lower than 3% wt.

The precursor is converted into catalyst components for the polymerization of olefins by reacting the precursor with a titanium compound.

In some embodiments, the titanium compounds have the formula Ti(OR)ₙX_{y-n} wherein n is between 0 and y; y is the valence of titanium; X is halogen and R is an alkyl radical having 1-8 carbon atoms or a COR group. In some embodiments, the titanium compounds have at least one Ti-halogen bond. In some embodiments, the titanium compounds are titanium tetrahalides or halogen alcoholates. In some embodiments, the titanium compounds are selected from the group consisting of TiCl₃, TiCl₄, Ti(OBu)₄, Ti(OBu)C₃, Ti(OBu)₂Cl₂, and Ti(OBu)₃C. In some embodiments, the reaction is carried out by suspending the adduct in cold TiCl₄. Then, the mixture is heated up to 80-130° C. and kept at this temperature for 0.5-2 hours. Next, the excess of TiCl₄ is removed and the solid component is recovered. In some embodiments, the treatment with TiCl₄ is carried out one or more times.

In some embodiments, the present disclosure provides a catalyst component for the polymerization of olefins made from or containing Mg, Ti, halogen and potassium, containing up to 50% mol with respect to Mg, of a K compound.

The amount of the titanium compound in the final catalyst component ranges from 0.1 to 10% wt, alternatively from 0.5 to 5% wt.

In some embodiments, the K compound is introduced into the solid catalyst component by adding the K compound during the treatment of the Mg based precursor with the titanium compound. In some embodiments, the K compound is in solution or suspension in the same medium used for the contact of the Mg based compound with the Ti compound.

In some embodiments, the reaction between the Ti compound and the adduct is carried out in the presence of an electron donor compound (internal donor). In some embodiments, the reaction is in preparation of a stereospecific catalyst for the polymerization of olefins. In some embodiments, the electron donor compound is selected from the group consisting of esters, ethers, amines, silanes and ketones. In some embodiments, the esters are selected from the group consisting of alkyl and aryl esters of mono or polycarboxylic acids. In some embodiments, the esters are selected from the group consisting of esters of benzoic, phthalic, malonic and succinic acid. In some embodiments, the esters are selected from the group consisting of n-butylphthalate, di-isobutylphthalate, di-n-octylphthalate, diethyl 2,2-diisopropylsuccinate, diethyl 2,2-dicyclohexyl-succinate, ethyl-benzoate and p-ethoxy ethyl-benzoate. In some embodiments, the ethers are selected from the group of 1,3 diethers of the formula:

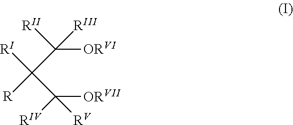

wherein R, R^{I}, R^{II}, R^{III}, R^{IV} and R^{V} equal or different to each other, are hydrogen or hydrocarbon radicals having from 1 to 18 carbon atoms, and R^{VI} and R^{VII}, equal or different from each other, have the same meaning of R-R^{V} except that R^{VI} and R^{VII} cannot be hydrogen. In some embodiments, one or more of the R-R^{VII} groups are linked to form a cycle. In some embodiments, the 1,3-diethers have R^{VI} and R^{VII} selected from C₁-C₄ alkyl radicals.

In some embodiments, the electron donor compound is present in molar ratio with respect to the magnesium between 1:4 and 1:60.

In some embodiments, the particles of the solid catalyst components have the same size and morphology as the adducts. In some embodiments, the size of the solid catalyst components ranges between 5 and 150 m.

In some embodiments, before the reaction with the titanium compound, the MgCl₂.n(ROH) precursors of the present disclosure is subjected to a dealcoholation treatment. In some embodiments, the dealcoholation treatment increases the porosity of the adduct. In some embodiments, the dealcoholation is carried out as described in European Patent Application No. EP-A-395083. In some embodiments, partially dealcoholated adducts are obtained having an alcohol content ranging from 0.1 to 2.6 moles of alcohol per mole of MgCl₂. After the dealcoholation treatment the adducts are reacted with the Ti compound, thereby obtaining the solid catalyst components.

In some embodiments, the solid catalyst components show a surface area (by B.E.T. method) ranging between 10 and 500 m²/g, alternatively between 20 and 350 m2/g, and a total porosity (by B.E.T. method) higher than 0.15 cm³/g, alternatively between 0.2 and 0.6 cm³/g.

The catalyst components form catalysts for the polymerization of alpha-olefins CH₂═CHR, wherein R is hydrogen or a hydrocarbon radical having 1-12 carbon atoms, by reaction with Al-alkyl compounds. In some embodiments, the alkyl-Al compound has the formula AlR_{3-z}X_{z}, wherein R is a C₁-C₁₅ hydrocarbon alkyl radical, X is halogen, and z is a number 0≤z<3. In some embodiments, the halogen is chlorine. In some embodiments, the Al-alkyl compound is selected from the group consisting of trialkyl aluminum compounds. In some embodiments, the trialkyl aluminum compounds is selected from the group consisting of trimethylaluminum triethylaluminum, triisobutylaluminum, tri-n-butylaluminum, tri-n-hexylaluminum, and tri-n-octylaluminum. In some embodiments, the alkyl-Al compounds are alkylaluminum halides, alkylaluminum hydrides or alkylaluminum sesquichlorides. In some embodiments, the alkylaluminum sesquichlorides are selected from the group consisting of AlEt₂C and Al₂Et₃Cl₃. In some embodiments, the alkylaluminum halides, alkylaluminum hydrides or alkylaluminum sesquichlorides are in mixture with trialkyl aluminum compounds.

In some embodiments, the Al/Ti ratio is higher than 1, alternatively between 50 and 2000.

In some embodiments, the polymerization system is further made from or containing an electron donor compound (external donor). In some embodiments, the external donor is the same as or different from the compound used as an internal donor. In some embodiments, the internal donor is an ester of a polycarboxylic acid while the external donor is selected from silane compounds containing at least a Si—OR link, having the formula Rₐ¹R_{b}²Si(OR³)_{c}, wherein a and b are integer from 0 to 2, c is an integer from 1 to 3 and the sum (a+b+c) is 4; R¹, R², and R³, are alkyl, cycloalkyl or aryl radicals with 1-18 carbon atoms. In some embodiments, the internal donor is a phthalate. In some embodiments, the silicon compounds have the values where a is 1, b is 1, c is 2, at least one of R¹ and R² is selected from branched alkyl, cycloalkyl or aryl groups with 3-10 carbon atoms and R³ is a C₁-C₁₀ alkyl group. In some embodiments, R³ is methyl. In some embodiments, the silicon compounds are selected from the group consisting of methylcyclohexyldimethoxysilane, diphenyldimethoxysilane, methyl-t-butyldimethoxysilane, and dicyclopentyldimethoxysilane. In some embodiments, the silicon compounds have the values where a is 0, c is 3, R² is a branched alkyl or cycloalkyl group and R³ is methyl. In some embodiments, the silicon compounds are selected from the group consisting of cyclohexyltrimethoxysilane, t-butyltrimethoxysilane and thexyltrimethoxysilane.

In some embodiments, the external donors are selected from the group consisting of cyclic ethers and 1,3 diethers. In some embodiments, the cyclic ether is tetrahydrofuran.

In some embodiments, the components and catalysts are used in processes for the polymerization or copolymerization of olefins of formula CH₂═CHR wherein R is hydrogen or a hydrocarbon radical having 1-12 carbon atoms.

In some embodiments, the catalysts are used in slurry polymerization using as diluent an inert hydrocarbon solvent or bulk polymerization using the liquid monomer as a reaction medium.

In some embodiments, the liquid monomer is propylene. In some embodiments, the catalysts are used in the polymerization process carried out in gas-phase operating in one or more fluidized or mechanically agitated bed reactors.

In some embodiments, the polymerization temperature ranges from 20 to 120° C., alternatively from 40 to 80° C. When the polymerization is carried out in gas-phase the operating pressure ranges between 0.1 and 10 MPa, alternatively between 1 and 5 MPa. In the bulk polymerization the operating pressure ranges between 1 and 6 MPa, alternatively between 1.5 and 4 MPa.

In some embodiments, the polyolefin products are selected from the group consisting of high density ethylene polymers (HDPE, having a density higher than 0.940 g/cc), made from or containing ethylene homopolymers and copolymers of ethylene with alpha-olefins having 3-12 carbon atoms; linear low density polyethylenes (LLDPE, having a density lower than 0.940 g/cc) and very low density and ultra low density (VLDPE and ULDPE, having a density lower than 0.920 g/cc, to 0.880 g/cc) made from or containing copolymers of ethylene with one or more alpha-olefins having from 3 to 12 carbon atoms, having a mole content of units derived from the ethylene higher than 80%; isotactic polypropylenes and crystalline copolymers of propylene and ethylene and/or other alpha-olefins having a content of units derived from propylene higher than 85% by weight; copolymers of propylene and 1-butene having a content of units derived from 1-butene between 1 and 40% by weight; heterophasic copolymers made from or containing a crystalline polypropylene matrix and an amorphous phase made from or containing copolymers of propylene with ethylene and or other alpha-olefins.

The following examples are given to further illustrate without limiting the disclosure.

### EXAMPLES

### Characterization

The properties reported below have been determined according to the following methods:

### Determination of Mg, Ti

The determination of Mg and Ti content in the solid catalyst component was carried out via inductively coupled plasma emission spectroscopy on “I.C.P Spectrometer ARL Accuris”.

The sample was prepared by analytically weighing, in a “Fluxy” platinum crucible”, 0.1 to 0.3 grams of catalyst and 2 grams of lithium metaborate/tetraborate 1/1 mixture. After addition of some drops of KI solution, the crucible was inserted in a “Claisse Fluxy” apparatus for complete burning. The residue was collected with a 5% v/v HNO₃ solution and then analyzed via ICP at the following wavelengths: Magnesium, 279.08 nm; Titanium, 368.52 nm.

### Determination of K

The determination of K content in the solid catalyst component was carried out via inductively coupled plasma emission spectroscopy on “I.C.P Spectrometer ARL Accuris”.

The sample was prepared by analytically weighing, in a “Fluxy” platinum crucible”, 0.1 to 0.3 grams of catalyst and 2 grams of lithium metaborate/tetraborate 1/1 mixture. After addition of some drops of LiI solution, the crucible was inserted in a “Claisse Fluxy” apparatus for complete burning. The residue was collected with a 5% v/v HNO₃ solution and then analyzed via ICP at the following wavelengths: Potassium, 766.49 nm.

### Determination of Li

The determination of Li content in the solid catalyst component was carried out via inductively coupled plasma emission spectroscopy on “I.C.P Spectrometer 3580”.

The sample was prepared by analytically weighing, in a “Fluxy” platinum crucible”, 0.1 to 0.3 grams of catalyst and 2 grams of sodium tetraborate. After addition of some drops of KI solution, the crucible was inserted in a “Claisse Fluxy” apparatus for complete burning. The residue was collected with a 5% v/v HNO₃ solution and then analyzed via ICP at the following wavelengths: Lithium, 670.78 nm.

### Determination of Na

The determination of Na content in the solid catalyst component was carried out via inductively coupled plasma emission spectroscopy on “I.C.P Spectrometer ARL Accuris”. The sample was prepared by analytically weighing, in a “Fluxy” platinum crucible”, 0.1 to 0.3 grams of catalyst and 2 grams of lithium metaborate/tetraborate 1/1 mixture. After addition of some drops of KI solution, the crucible was inserted in a “Claisse Fluxy” apparatus for complete burning. The residue was collected with a 5% v/v HNO₃ solution and then analyzed via ICP at the following wavelengths: Magnesium, 279.08 nm; Titanium, 368.52 nm; sodium, 589.59 nm.

### Determination of Internal Donor Content

The content of internal donor in the solid catalytic compound was determined by gas chromatography. The solid component was dissolved in acetone, an internal reference was added, and a sample of the organic phase was analyzed in a gas chromatograph, thereby determining the amount of donor present at the starting catalyst compound.

### Determination of X.I.

2.5 g of polymer and 250 ml of o-xylene were placed in a round-bottomed flask provided with a cooler and a reflux condenser and kept under nitrogen. The resulting mixture was heated to 135° C. and kept under stirring for about 60 minutes. The final solution was allowed to cool to 25° C. under continuous stirring, and the insoluble polymer was then filtered. The filtrate was then evaporated in a nitrogen flow at 140° C. to reach a constant weight. The content of the xylene-soluble fraction is expressed as a percentage of the original 2.5 grams and then, by difference, the X.I. %.

### Melt Flow Rate (MIL)

The melt flow rate MIL of the polymer was determined according to ISO 1133 (230° C., 2.16 Kg).

### EXAMPLES

### General Procedure for the Polymerization of Propylene

A 4-liter steel autoclave equipped with a stirrer, pressure gauge, thermometer, catalyst feeding system, monomer feeding lines and thermostatic jacket, was purged with nitrogen flow at 70° C. for one hour. A suspension containing 75 ml of anhydrous hexane, 0.76 g of AlEt₃ (6.66 mmol), 0.33 mmol of external donor and 0.010 g of solid catalyst component, precontacted for 5 minutes, was charged. Dicyclopentyldimethoxysilane, D donor, or cyclohexylmethyldimethoxysilane, C donor, was used as an external donor as reported in the following tables.

The autoclave was closed and the hydrogen was added (2 NL in D donor tests and 1.5 NL in C donor tests). Then, under stirring, 1.2 kg of liquid propylene was fed. The temperature was raised to 70° C. in about 10 minutes and the polymerization was carried out at this temperature for 2 hours. At the end of the polymerization, the non-reacted propylene was removed; the polymer was recovered and dried at 70° C. under vacuum for 3 hours. Then the polymer was weighed and characterized.

### Examples 1-2

### Procedure for the Preparation of the Spherical Adduct

Microspheroidal MgCl₂.C₂H₅OH adduct was prepared according to the method described in Comparative Example 5 of Patent Cooperation Treaty Publication No. WO98/44009, with the difference that KOH was dissolved in ethanol and added before feeding of the oil. The amount of KOH used is in shown in Table 1.

### Preparation of the Solid Catalyst Component

Into a 500 ml round bottom flask, equipped with a mechanical stirrer, a cooler and a thermometer, 300 ml of TiCl₄ were introduced at room temperature under nitrogen atmosphere.

After cooling to 0° C., while stirring, diisobutylphthalate and 12.0 g of the spherical adduct were sequentially added into the flask. The amount of charged internal donor met a Mg/donor molar ratio of 8. The temperature was raised to 100° C. and maintained for 1 hour. Thereafter, stirring was stopped, the solid product was allowed to settle. The supernatant liquid was siphoned off at 100° C. Additional fresh TiCl₄ was added to reach the initial liquid volume again. The mixture was then heated at 120° C. and kept at this temperature for 1 hour. Stirring was stopped again. The solid was allowed to settle. The supernatant liquid was siphoned off at 120° C. Additional fresh TiCl₄ was added to reach the initial liquid volume again. The mixture was then heated at 120° C. and kept at this temperature for 0.5 hour.

The solid was washed with anhydrous hexane six times in temperature gradient down to 60° C. and one time at room temperature. The resulting solid was then dried under vacuum and analyzed. The characterization of the catalyst is reported in Table 1. The polymerization results are reported in Table 1.

### Comparative Example 1

The same procedure described for the preparation of the support of Example 1 was repeated with the difference that KOH was not used. The catalyst was prepared and the polymerization test was carried out as described in Example 1. The polymerization results are reported in Table 1.

### Example 3

Into a 500 ml round bottom flask, equipped with a mechanical stirrer, a cooler and a thermometer, 300 ml of TiCl₄ were introduced at room temperature under nitrogen atmosphere. After cooling to 0° C., while stirring, 9,9-bis(methoxymethyl)fluorene and 12.0 g of the spherical adduct were sequentially added into the flask. The amount of charged internal donor met a Mg/donor molar ratio of 6. The temperature was raised to 100° C. and maintained for 1 hour. Thereafter, stirring was stopped, the solid product was allowed to settle. The supernatant liquid was siphoned off at 100° C. Additional fresh TiCl₄ was added to reach the initial liquid volume again. The mixture was then heated at temperature in the range of 110° C. and kept at this temperature for 1 hour. Stirring was stopped again. The solid was allowed to settle. The supernatant liquid was siphoned off at 110° C. Additional fresh TiCl₄ was added to reach the initial liquid volume again. The mixture was then heated at 110° C. and kept at this temperature for 0.5 hour. The solid was washed with anhydrous hexane six times in temperature gradient down to 60° C. and one time at room temperature. The resulting solid was then dried under vacuum and analyzed. The polymerization results are reported in Table 2.

### Comparative Example 2

The same procedure described for the preparation of the catalyst of example 3 was followed with the difference that support did not contain KOH. The polymerization results are reported in Table 2.

### Example 4

A spherical adduct was prepared as described in example 1 with the difference that KOEt was used instead of KOH.

A catalyst component was prepared by repeating the procedure reported in Example 1.

The resulting catalyst was used in the polymerization of propylene. The polymerization results are reported in Table 3.

### Comparative Examples 3-5

The same procedure described for the preparation of the example 4 was repeated with the difference that instead of KOEt the compounds reported in Tale 3 have been used. The polymerization results are reported in the same Table.

### Example 5

The same procedure described for the preparation of the catalyst according to Example 1 was repeated with the difference that, before being used in the preparation of the solid catalyst component, the support was partially dealcoholated up to a final amount of 24% wt of EtOH. The polymerization results are reported in Table 4.

### Example 6

The same procedure described for the preparation of the catalyst of example 5 was followed with the difference that support did not contain KOH. The polymerization results are reported in Table 4.

TABLE 1
KOH doped phthalate-based solid catalyst components

| | Support | | | | | | | | | | | |
|---|---|---|---|---|---|---|---|---|---|---|---|---|
| | Synthesis | Support Composition | | | Solid Catalyst Component | | | | | | | |
| | KOH/Mg | Mg | K | | Mg | Ti | K | DIBP | Polymerization | | | |
| | % | % | % | EtOH/Mg | % | % | % | % | ED | Mileage | XI | MIL |
| | mol | wt. | mol | m.r. | wt. | wt. | mol | wt. | type | Kg/g | % wt. | g/10' |
| Ex. 1 | 1.5 | 10.3 | 1.2 | 3.0 | 18.7 | 2.6 | 1.2 | 11.2 | D | 100.1 | 98.6 | 2.2 |
| Ex. 2 | 3.0 | 9.9 | 2.8 | 2.9 | 18.3 | 2.8 | 2.5 | 10.6 | D | 98.9 | 98.8 | 2.0 |
| C1 | — | 9.9 | — | 3.0 | 19.2 | 2.4 | — | 10.8 | D | 89.6 | 98.6 | 2.6 |

DIBP = diisobutylphthalate

TABLE 2
KOH doped diether-based solid catalyst components

| | Support | | | | | | | | | | | |
|---|---|---|---|---|---|---|---|---|---|---|---|---|
| | Synthesis | Support Composition | | | Solid Catalyst Component | | | | | | | |
| | KOH/Mg | Mg | K | | Mg | Ti | K | | Polymerization | | | |
| | % | % | % | EtOH/Mg | % | % | % | Diether | ED | Mileage | XI | MIL |
| | mol | wt. | mol | m.r. | wt. | wt. | mol | % wt. | type | Kg/g | % wt. | g/10' |
| Ex. 3 | 1.5 | 10.4 | 1.2 | 2.7 | 13.8 | 5.4 | 1.0 | 16.3 | C | 105.7 | 98.3 | 4.2 |
| C 2 | — | 10.4 | — | 2.8 | 14.0 | 4.9 | — | 19.9 | C | 93.7 | 98.2 | 2.8 |

Diether = 9,9-bis(methoxymethyl)fluorene

TABLE 3
MtOEt doped phthalate-based solid catalyst components

| | Support | | | | | | | | | | | | |
|---|---|---|---|---|---|---|---|---|---|---|---|---|---|
| | Synthesis | | Support Composition | | | Solid Catalyst Component | | | | | | | |
| | | Mt/Mg | Mg | Mt | | Mg | Ti | Mt | DIBP | Polymerization | | | |
| | MtOEt | % | % | % | EtOH/Mg | % | % | % | % | ED | Mileage | XI | MIL |
| | Type | mol | wt. | mol | m.r. | wt. | wt. | mol | wt. | type | Kg/g | % wt. | g/10' |
| Ex. 4 | KOEt | 1.5 | 10.1 | 1.4 | 3.0 | 18.7 | 2.6 | 1.2 | 10.4 | D | 101.2 | 98.7 | 1.9 |
| C3 | LiOEt | 1.5 | 9.9 | 1.8 | 2.9 | 18.1 | 3.0 | 0.9 | 12.9 | D | 72.3 | 98.3 | 2.0 |
| C4 | LiOEt | 3.0 | 8.9 | 3.1 | 3.2 | 17.3 | 2.3 | 1.6 | 11.5 | D | 60.0 | 98.2 | 2.2 |
| C5 | NaOEt | 1.5 | 10.2 | 1.6 | 3.1 | 19.0 | 2.4 | 0.6 | 12.0 | D | 84.8 | 98.6 | 3.1 |

DIBP = diisobutylphthalate

TABLE 4
KOH doped phthalate-based solid catalyst components (de-alcoholated)

| | Support | | | | | | | | | | | |
|---|---|---|---|---|---|---|---|---|---|---|---|---|
| | Synthesis | Support Composition | | | Solid Catalyst Component | | | | | | | |
| | KOH/Mg | Mg | K | | Mg | Ti | K | DIBP | Polymerization | | | |
| | % | % | % | EtOH/Mg | % | % | % | % | ED | Mileage | XI | MIL |
| | mol | wt. | mol | m.r. | wt. | wt. | mol | wt. | type | Kg/g | % wt. | g/10' |
| Ex. 5 | 3.0 | 10.9 | 2.6 | 2.4 | 18.4 | 3.6 | 2.5 | 8.6 | D | 96.1 | 98.4 | 1.8 |
| C6 | — | 11.6 | — | 2.2 | 19.3 | 2.3 | — | 10.5 | D | 78.2 | 98.5 | 2.7 |

DIBP = diisobutylphthalate

What is claimed is:

1. An olefin polymerization catalyst precursor comprising:
a complex of formula MgCl₂.n(ROH) wherein R is a C₁-C₁₀ hydrocarbon group and n ranges from 0.3 to 6, and
up to 50% mol with respect to Mg, of a K compound selected from the group consisting of halides, carbonate, carboxylates of formula R¹COO⁻ and compounds of formula K(OR¹) wherein R¹ is H or a C₁-C₁₀ hydrocarbon group.

2. The precursor of claim 1, wherein the K compound is selected from the group consisting of chloride, alcoholates, carbonate, hydroxide and mixture thereof.

3. The precursor of claim 2, wherein the K compound has the formula K(OR¹) wherein R¹ is H or a C₁-C₁₀ hydrocarbon group.

4. The precursor of claim 1, wherein n ranges from 0.5 to 5.

5. The precursor of claim 1, wherein the K compound is present in an amount lower than 25% by mol with respect to Mg.

6. The precursor of claim 5, wherein the K compound is present in the precursor in an amount lower than 7% by mol with respect to Mg.

7. The precursor of claim 3, wherein K(OR¹) is KOH or KOEt.

8. The precursor of claim 1, wherein the MgCl₂.n(ROH) complex is partially dealcoholated.

9. Catalyst components for the polymerization of olefins obtained by reacting the precursor of claim 1 with a titanium compound.

10. The catalyst components of claim 9, wherein the K compound is present in an amount lower than 15% by mol with respect to Mg.

11. The catalyst components of claim 9, further comprising an electron donor compound (internal donor).

12. The catalyst components of claim 11, wherein the electron donor compound (internal donor) is selected from the group consisting of esters, ethers, amines, silanes and ketones.

13. A catalyst for the polymerization of alpha-olefins CH₂═CHR, wherein R is hydrogen or a hydrocarbon radical having 1-12 carbon atoms, obtained by reacting the catalyst components of claim 9 with Al-alkyl compounds optionally in the presence of an external electron donor compound.

14. The catalyst of claim 13, wherein the external electron donor compound is selected from compounds having the formula Rₐ¹R_{b}²Si(OR³)_{c}, wherein a and b are integer from 0 to 2, c is an integer from 1 to 3 and the sum (a+b+c) is 4; R¹, R², and R³, are alkyl, cycloalkyl or aryl radicals with 1-18 carbon atoms.

15. A process for the polymerization of olefins carried out in the presence of the catalyst of claim 13.
